(19) United States
(12) Patent Application Publication
(10) Pub. No.: US 2014/0258267 A1
(43) Pub. Date: Sep. 11, 2014

(54) Aggregating and Searching Social Network Images

(71) Applicant: MICROSOFT CORPORATION, Redmond, WA (US)

(72) Inventors: Yi-An Lin, Sunnyvale, CA (US); Timothy Andrew Harrington, Mountain View, CA (US); Guenther Schmuelling, San Jose, CA (US); Zhi Liang Lu, San Jose, CA (US)

(73) Assignee: MICROSOFT CORPORATION, Redmond, WA (US)

(21) Appl. No.: 13/790,396

(22) Filed: Mar. 8, 2013

(51) Int. Cl. G06F 17/30

(52) U.S. Cl. CPC G06F 17/30554
USPC 707/722

(57) ABSTRACT

Methods and systems directed to aggregating social content from social networking sites, and making the social content available for searching is disclosed. Social content, corresponding to multiple computer users, is obtained from a plurality of social networking sites. The social content is stored in a content store, making it available for searching. In response to receiving a search query (directed to social content), a set of search results is identified, the search results including at least one item of social content obtained from a social networking site. The social content in the search results is filtered according to privacy constraints. A presentation of the filtered search results is generated and provided to the requesting computer user.

### BACKGROUND

More and more people are posting content on Internet via social networking sites. Unfortunately, once a person posts content on the social networking site, it is often difficult to locate, especially after a period of time and after that person posts other content. This is especially difficult to locate content if a person posts the content in the domain of another person, e.g., posting a comment on a friend's “wall”, tagging an image posted by another person identifying one or more persons in the image, etc. Indeed, search services, including search services of social networking sites and general search engines, are unable to respond to a query that for content posted on a social networking site. For example, a search engine cannot respond with good results to a search query such as “image of my friend Steve at Lake of the Angels,” even when the person submitting the search query knows that there are one or more images of his/her friend, “Steve,” while at the “Lake of Angels,” posted on at least one social networking site.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A method directed to aggregating social content from social networking sites, and making the social content available for searching is described. Social content, corresponding to multiple computer users, is obtained from a plurality of social networking sites. The social content is stored in a content store, making it available for searching. In response to receiving a search query (directed to social content), a set of search results is identified, the search results including at least one item of social content obtained from a social networking site. The social content in the search results is filtered according to privacy constraints. A presentation of the filtered search results is generated and provided to the requesting computer user.

A computer system for responding with search results to a search query is also described. The computer system includes a processor and a memory, wherein the processor executes instructions stored in the memory as part of or in conjunction with additional components to respond to a search query. Additionally, the computer system includes a key extraction component that extracts key terms from each instance of social content and stores the social content in a content store and indexed according to the key terms. A query parsing component identifies a plurality of key terms for identifying social content in the content store. A content retrieval component that identifies a set of search results from the content store, wherein the set of search results includes at least one instance of social content. An access filter component filters the set of search results according to access privileges of the requesting computer user with regard to the at least one instance of social content. A presentation generation component generates a presentation of the filtered set of search results and returns the presentation to the requesting computer user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter;

FIG. 2 is a block diagram illustrating the flow of social content from social networking sites to a search service, such as a search engine, where the content is made available for searching;

FIG. 3 is a flow diagram illustrating an exemplary routine for obtaining social content from social networking sites and making the content available for searching;

FIG. 4 is a flow diagram illustrating an exemplary routine for responding to a search query for social content from a social networking site;

FIG. 5 is a flow diagram illustrating an exemplary sub-routine, suitable for use in the routine of FIG. 4, for ensuring that a requesting computer user has sufficient access privileges to view the social content that satisfy the requesting computer user's search query;

FIG. 6 is a pictorial diagram illustrating an exemplary user interface showing the presentation of search results with regard to a search query directed to social content available at a social networking site;

FIG. 7 as a pictorial diagram illustrating an alternative exemplary user interface showing the presentation of search results with regard to a search query directed to images available at a social networking site; and;

FIG. 8 is a block diagram illustrating exemplary components of a search engine configured according to aspects of the disclosed subject matter.

### DETAILED DESCRIPTION

For purposed of clarity, the use of the term “exemplary” in this document should be interpreted as serving as an illustration or example of something, and it should not be interpreted as an ideal and/or a leading illustration of that thing. Additionally, the term “social content” refers to content that is uploaded to a network site such that the content may be viewed by one or more other persons/computer users. While much of the description of the disclosed subject matter is made with regard to images, images are just an example of social content. Social content may include, by way of illustration and not limitation: images, videos, hyperlinks, textual posts, comments, audio files, check-in data, and likes. In obtaining social content from a social networking site, both the social content (i.e., the content that was posted to the social networking site) and content data (i.e., information that relates to the posted content) are obtained, though the two parts may not necessarily be obtained at the same time. A “social networking site” refers to a network location where persons/computer users are able to upload social content such that it may be viewed by one or more other persons/computer users.

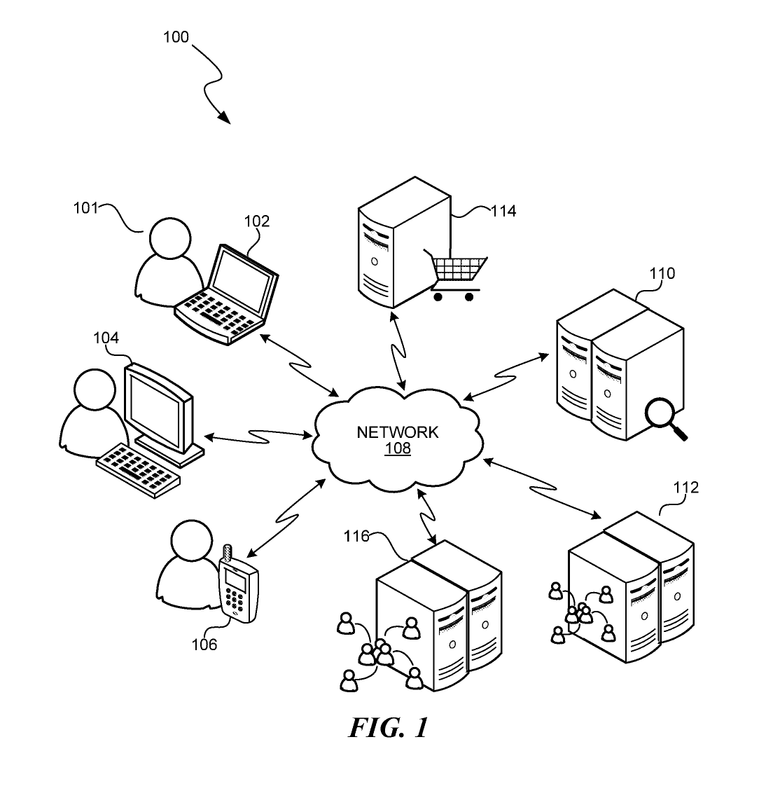

Turning now to the figures, FIG. 1 is a block diagram illustrating an exemplary networked environment 100 suitable for implementing aspects of the disclosed subject matter, including aggregating and searching for social content. The illustrative networked environment 100 includes one or more user computers, such as user computers 102-106, connected to a network 108, such as the Internet, a wide area network or WAN, and the like. Also connected to the network 108 is a search engine 110 configured to provide search results in response to search queries received from one or more computer users, such as computer user 101 by way of user computer 102 over the network 108. According to aspects of the disclosed subject matter, the search engine 110 is configured such that it is able to aggregate social content from social networking sites and make the social content available for searching.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as computer user 101 using user computer 102 over the network 108. In particular, responsive to receiving a search query from a computer user, the search engine 110 obtains search results information related and/or relevant to the received search query (as defined by one or more query terms of search query.) The search results information includes search results, i.e., references (typically in the form of hyperlinks) to relevant content available at various network locations located throughout the network 108, such network sites 112-116. The content sites may include (by way of illustration and not limitation): social networking sites, such as social networking sites 112 and 116; online shopping sites, such as online shopping site 114; news outlets (not shown); educational and research sites (not shown); and the like.

It should be appreciated that while much of the following discussion will be made with regard to a search engine 110 that is separate from a social networking site, such as social networking sites 112 and 116, this should not be construed as limiting upon the disclosed subject matter. Indeed, aspects of the disclosed subject matter may be suitably implemented in the search services of the various social networking sites, such as social networking sites 112 and 116. Moreover, social content may be obtained from any number of sources, not just social networking sites. For example, a computer user may post a comment/review with regard to a product available on a shopping site, such as shopping site 114. This product review may be obtained by a search engine 110 and made available for searching in accordance to aspects of the disclosed subject matter.

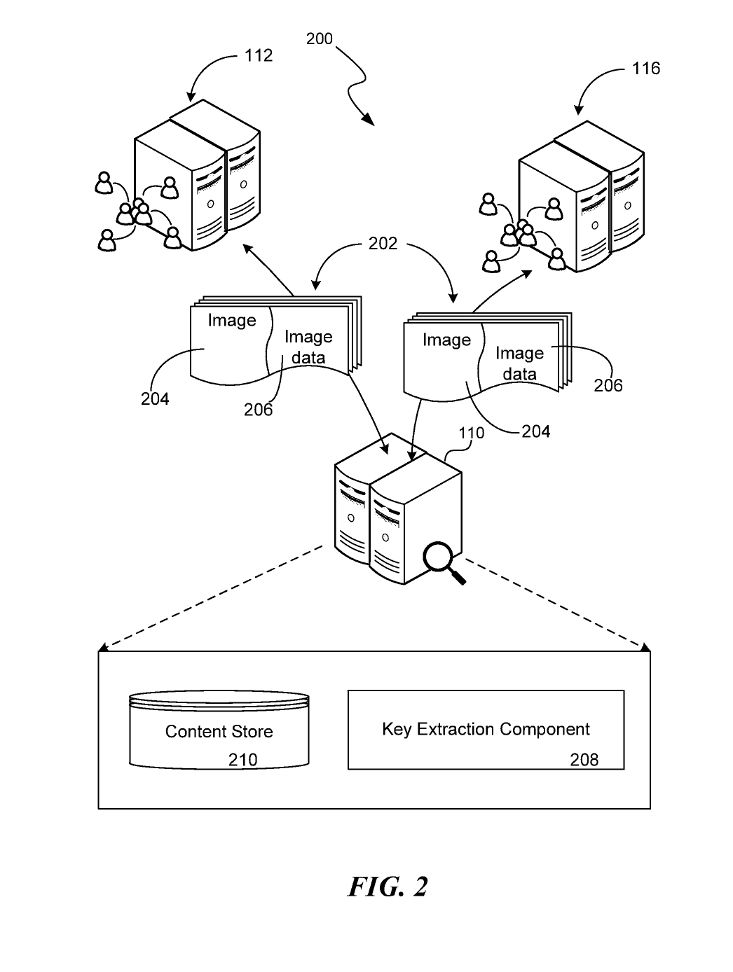

To better appreciate how the search engine 110 aggregates social content from social networking sites, reference is made to FIG. 2. FIG. 2 is a block diagram illustrating the flow of social content from social networking sites to a search service, such as a search engine 110, where the content is made available for searching. For ease of description, the discussion of FIG. 2, as well as addition description thereafter, will be made with regard to a specific embodiment of social content: images. However, while the subsequent description will be made in regard to processing images from social networking sites, this should be view as illustrative and not limiting of the novel aspects of the disclosed subject matter.

As shown in FIG. 2, a search engine 110 obtains image content 202 from one or more social networking sites, such as social networking sites 112 and 116. The image content 202 will typically include both image 204 (either the image or a reference to the image) and related image data 206. Of course, it should be noted that while FIG. 2 illustrates that the image 204 and related image data 206 are obtained together, this is for illustration purposes. In various embodiments, the image 204 and related image data 206 may be obtained separately.

While obtaining the image 204 or a link to the image at the social networking site is important for the search engine 110 (so that it can serve up the image in response to a search query), obtaining related image data 206 is also important. According to aspects of the disclosed subject matter, the search engine uses the related image data 206 to identify keys and other aspects or factors upon which the image can be indexed in a content store. Generally speaking, the search engine 110 uses numerous aspects of the related image data 206 to identify keys/criteria/factors that help identify the particular image. These aspects include (by way of illustration and not limitation): the album title in which the obtained image is found; album comments—from both the image poster as well as other persons allowed to comment on the album at the social networking site; tagged entities in the image, including people and/or places; image titles; images comments; location information regarding the geographic location of subject of the image; the date and/or time that the image was taken; the number of “likes” that the image has received; popularity of the item, e.g., the number of times that the image has been viewed; the number of times that the image has been shared (reposted) by others; and the date the image was uploaded to the social networking site. Also included in the related image data 206 is an Uploader ID (identifier), the Uploader ID being an identifier corresponding to the person/computer user that uploaded the image to the social networking site. As will be discussed below, the Uploader ID plays an important function in determining whether a requesting computer user has sufficient privileges to access a given image.

Upon receiving the image content 202, the search engine 110 examines the related image data 206 and identifies and/or determines criteria, referred to as “key terms,” upon which the image may be indexed in a content store for efficient retrieval. According to various embodiments of the disclosed subject matter, the search engine 110 extracts the key terms from the image content 202 via a key extraction component 208. Once the key terms are identified, the image content 202, comprising the image 204 and related image data 206, is stored in the content store 210, indexed according to the identified key terms.

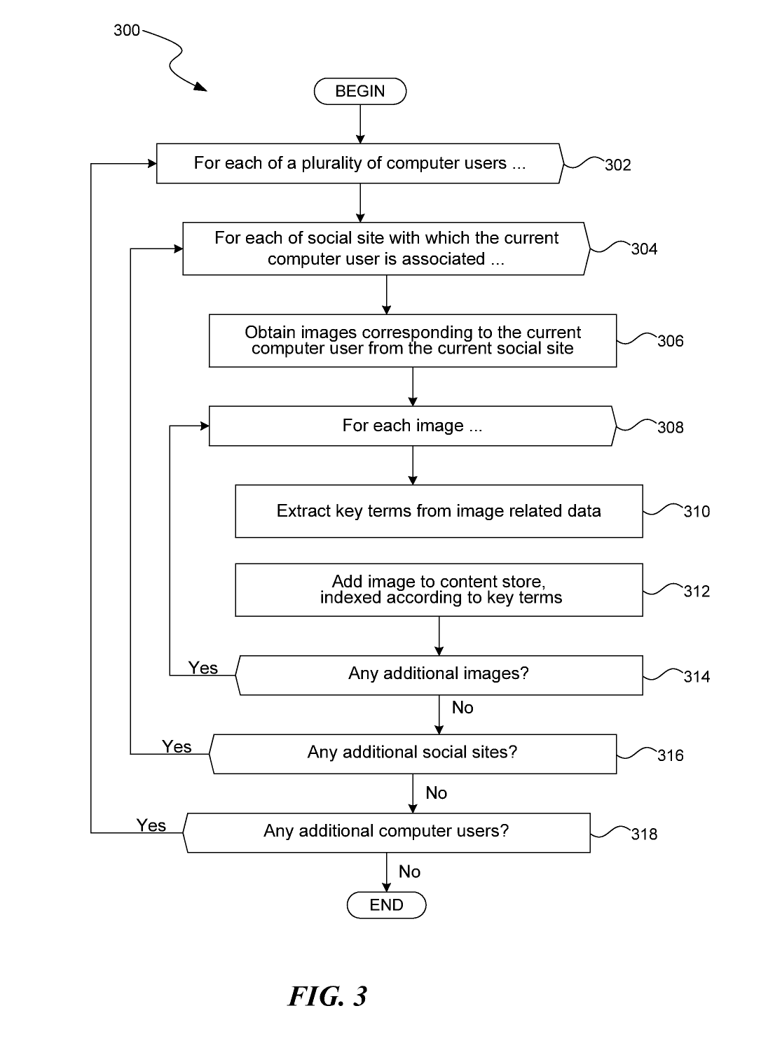

Turning now to FIG. 3, FIG. 3 is a flow diagram illustrating an exemplary routine 300 for obtaining social content 202 from social networking sites and making the social content available for searching. Beginning at block 302, an iteration loop is begun to iterate through each of a plurality of computer users associated with social networking sites. For clarity in the following discussion, the term “current computer user” refers to the computer user currently being processed in the iteration loop.

At block 304, another iteration loop is begun in which the process iterates through each social networking site associated with the current computer user. In this manner, the process is able to obtain image data associated with the current computer user from each of the social networking sites with which the computer user is associated, and where image data regarding the current computer user is found. As with the prior iteration loop, the term “current social networking site” refers to the social networking site currently being processed in this iteration loop.

At block 306, the process obtains image content 202 corresponding to the current user from the current social networking site. As mentioned above in regard to FIG. 2, the image content 202 includes both the image (or a reference to the image) and related image data. According to various embodiments, the image and the related image data may be obtained jointly or, in the alternative, the image data may be obtained separately from the current social networking site.

At block 308, yet another iteration loop is begun in which the process iterates through each of the images obtained for the current computer user from the current social networking site. As with the other iteration loops, the image that is currently being processed in the iteration loop is referred to as the “current image.” At block 310, key terms are extracted from the image data 206 associated with the current image. At block 312, the image content 202 (including the image 204 or a link to the image, and the image data 206) is added to the content store 210 and indexed according to the extracted key terms. At block 314, if there are any additional images to be processed, the routine 300 returns to block 308 where the next image is selected as the current image for processing, and the loop repeats for the current image. However, if there are no more images for the current user from the current social networking site to be processed, the routine proceeds to block 316.

At block 316, if there are any additional social networking sites associated with the current computer user, the routine 300 returns to block 304 where the next social networking site is selected as the current social networking site for processing and the iteration loop repeats. However, if there are no more social networking sites corresponding to the current user from which image content 202 may be obtained, the routine proceeds to block 318.

At block 318, if there are any additional computer users to be processed, the routine 300 returns to block 302 where the next computer user is selected as the current computer user and the loop repeats as described above. However, if there are no more computer users for processing, the routine 300 terminates.

Those skilled in the art should appreciate that the process described in routine 300 is only one example of a routine suitable for processing image content (or, of a more general nature, social content). Indeed, those skilled in the art will appreciate that obtaining image content and then processing it may be performed in any number of manners. Significantly, image content 202 (or, more generally, social content) corresponding to a computer user is obtained from a plurality of social networking sites, the image content includes a source (Uploader ID), key terms are extracted from the image data, and the image content is stored in the content store 210 and indexed according to one or more of the extracted key terms.

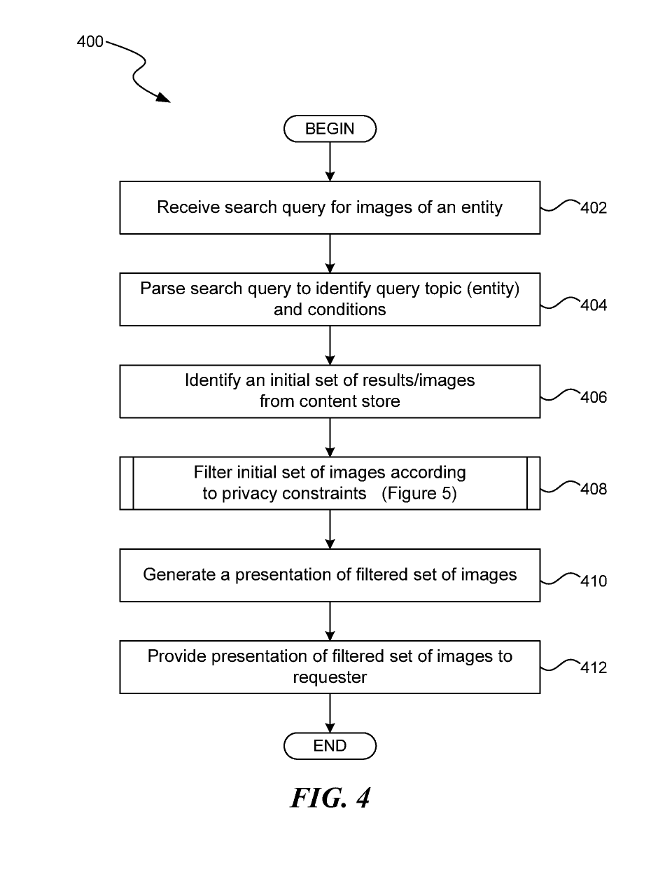

While routine 300 describes a process for aggregating image content (or, more generally, social content) into a content store 210, FIG. 4 illustrates an exemplary routine 400 for responding to a search query with regard to an image/social content that has been uploaded to a social networking site. Beginning at block 402, a search engine 110 receives a search query from a requesting computer user regarding an image relating to an identified entity. An exemplary search query may be “Image of my friend Steve at Lake of the Angels.”

At block 404, the routine 400 parses the search query to identify the query topic (or topics) and conditions of the search query. With reference to the example of above, in parsing the search query the routine 400 identifies “my friend Steve” as the query topic, as well as identifying sub-topics and/or conditions such as “image” and “Lake of the Angels.” Of course, in this example the search engine 110 may consult with one or more networking sites associated with the requesting computer user to accurately identify “my friend Steve.” Thus, at block 406, a set of images are identified from the content store 210 that are relevant to the search query, both the query topic as well as the conditions. These results are available for searching since the images have been stored and indexed in the content store 210.

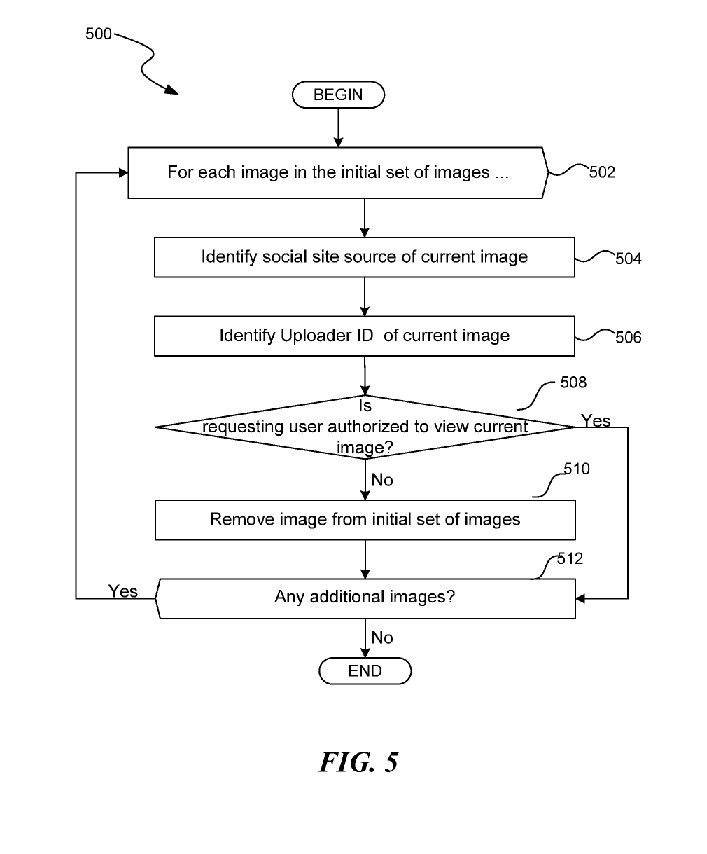

As those skilled in the art will appreciate, the images (or, more generally, social content) that are posted on social networking sites are often posted by people that have various access restrictions in place as to who is able to view the posts and who is not. Thus, at block 408, the initial set of results/images may or may not be accessible to the requesting computer user based on the access restrictions of the person that posted the content in the first place. Thus, the initial set of search results/images is filtered according to privacy constraints. FIG. 5 is a flow diagram illustrating an exemplary sub-routine 500 for filtering out search results to which the requesting user does not have current access permissions.

Beginning at block 502, an iteration loop is begun to iterate through each of the images in the initial set of resulting images, with each image being processed in the iteration loop being referred to as the “current image.” Since each social networking site may have its own privacy policies and each user may establish different privacy settings for access to content that he/she posts on the social networking site, at block 504 the social networking site associated with the current image is identified from the image data 206 that was stored as part of the image content 202 in the content store 210. Additionally, the Uploader ID (identifier for the user that uploaded the image to the social networking site) is also identified from the image content 202 in the content store 210.

At decision block 508, the identified social networking site is queried as to whether the requesting computer user (typically identified by a user identifier) has permission to access/view the current image (based on the Uploader ID). If the response is that the requesting computer user has permission to access the image, the routine 500 proceeds to block 512 where the process determines whether there are any additional images to examine in the process. However, if at decision block 508 it is determined that the requesting computer user does not have sufficient privileges to access the current image, the routine 500 proceeds to block 510. At block 510, the current image is removed from the set of images selected as potential search results for the search query.

At block 512, if there are additional images in the initial set to validate, the routine 500 returns to block 502 where the next image in the set of images is selected as the current image and the described above repeats. Alternatively, if there are no additional images to validate (i.e., check whether the requesting computer user has sufficient privilege to access/view), the routine 500 has completed filtering the initial set of images and, correspondingly, terminates.

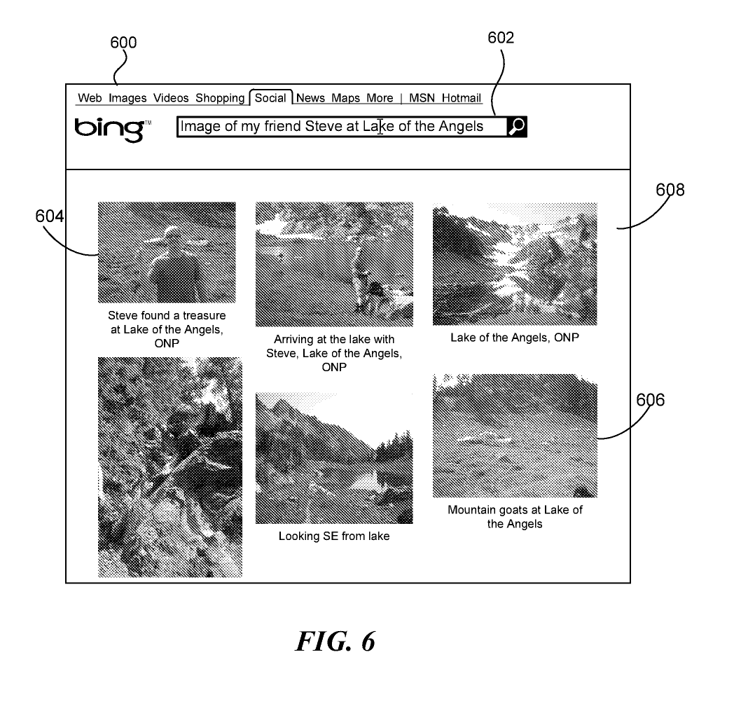

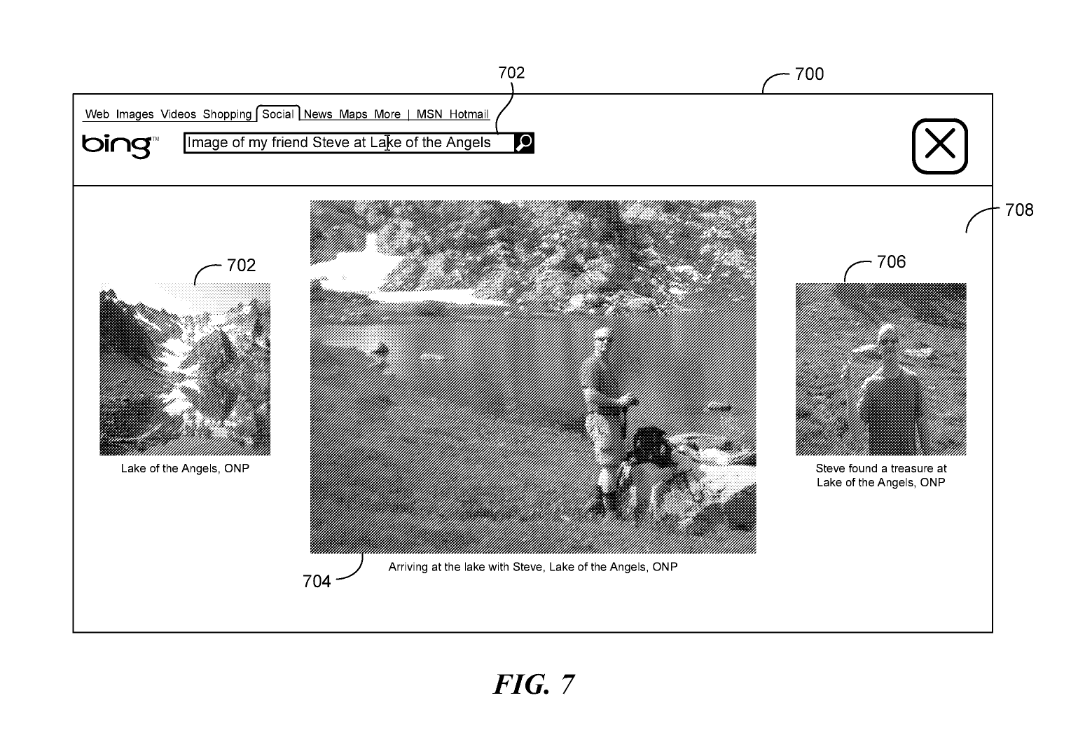

Returning again to FIG. 4, after having filtered the initial set of images according to privacy constraints, routine 400 proceeds to block 410. At block 410, a presentation of the filtered set of images is generated in response to the search query. While any number of presentations may be generated as the presentation of the filtered set of search results, including one or more typical search results pages, a discussion of exemplary presentations tailored to images is set forth below in regard to FIGS. 6 and 7. Thereafter, at block 412 the presentation of the filtered set of images responsive to the search query is provided to the requesting computer user, and the routine 400 terminates.

Regarding routines 300, 400 and 500, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 300, 400 and 500 may be carried out in parallel or in series. Often, but not exclusively, the functionality of the various routines is embodied in software (e.g., applications, system services, libraries, and the like) that is executed on computer hardware and/or systems described below in regard to FIG. 800.

It should be appreciated that while many novel aspects of the disclosed subject matter are expressed in routines, applications (also referred to as computer programs), apps (small, generally single or narrow purposed, applications), and/or methods, these aspects may also be embodied as computer-executable instructions stored in computer-readable media, also referred to as computer-readable storage media. As those skilled in the art will recognize, computer-readable media can host computer-executable instructions for later retrieval and execution. When executed on a computing device, the computer-executable instructions stored on one or more computer-readable storage devices carry out various steps, methods and/or functionality, including those steps, methods, and routines described above in regard to routines 300, 400 and 500. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 6, FIG. 6 is a pictorial diagram 600 illustrating an exemplary user interface showing the presentation of search results with regard to a search query directed to images (or, more generally, social content) available at a social networking site. As shown in FIG. 6, an exemplary search query, “Image of my friend Steve at Lake of Angels,” returns various images arranged in a “pinboard view” arrangement, including images 604 and 606. As discussed above, the images were identified according to the key terms identified in the image content data. In this exemplary display, the image view 608 may be scrolled up and down via a touch interface, though this is a non-limiting example. In other embodiments (not shown), scrolling devices may be provided that enable the computer user to scroll the resultant images in the image view 608, using input devices such as a mouse, keyboard, joystick, touchpad, and the like.

In contrast to the pinboard view arrangement of FIG. 6, FIG. 7 illustrates a “slideshow view” arrangement for the same exemplary search query 702. As with the pinboard view arrangement of FIG. 6, FIG. 7 illustrates the images 702-706 resulting from the search query “Image of my friend Steve at Lake of the Angels.” In contrast to the pinboard view, the slideshow view enables the requesting computer user to scroll the images horizontally through the display view 708 using a swipe touch gesture. Of course, while not shown, other input paradigms may be used; e.g., scrolling devices may be provided that enable the computer user to scroll the resultant images in the image view 608, using input devices such as a mouse, keyboard, joystick, touchpad, voice controls/commans, and the like.

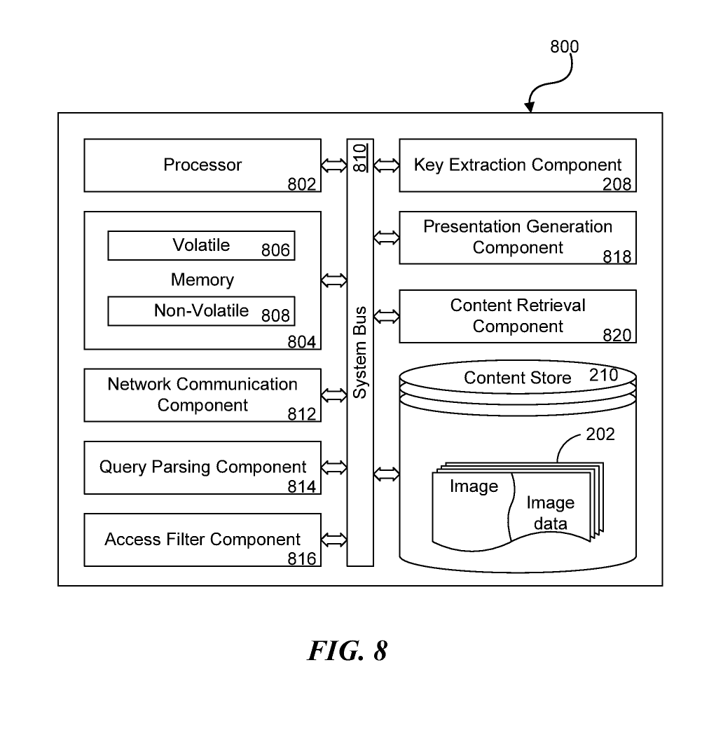

FIG. 8 is a block diagram illustrating exemplary components of a search engine configured according to aspects of the disclosed subject matter. As described above, the search engine 110 is configured to aggregate social content from one or more social networking sites and make the aggregated content available for searching. As shown in FIG. 8, the search engine 800 includes a processor 802 (or processing unit) and a memory 804 interconnected by way of a system bus 810. As those skilled in the art will appreciated, memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory whereas ROM and memory cards are examples of non-volatile memory.

The processor 802 executes instructions retrieved from the memory 804 in carrying out various functions, particularly in aggregating social content from various social networking sites and making the aggregated content available for searching. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 810 provides an interface for search engine's components to inter-communicate. The system bus 810 can be of any of several types of bus structures that can interconnect the various components (including both internal and external components). The illustrative search engine 110 further includes a network communication component 812 for interconnecting the search engine with other computers (such as user computers 102-106 and networking sites 112-116) as well as other devices on a computer network 108. The network communication component 812 may be configured to communicate with an external network, such as network 108, via a wired connection, a wireless connection, or both.

The exemplary search engine 110 further includes a query parsing component 814. As previously suggested, the query parsing component 814 parses search queries received from computer users in order to identify a query topic (or topics), sub-topics, conditions such that the search engine 110 is able it identify a set of search results of social content responsive to the query. These topics and conditions are used as keys by a content retrieval component 820 to identify and/or retrieve social content in the content store 210 that satisfies the search query. An access filter component 816 filters potential search results according to current access permissions before the search engine provides the identified search results to the computer user. A presentation generation component 818 generates a presentation of the identified search results for the requesting computer user, such as the pinboard or slideshow views described in FIGS. 6 and 7. The search engine 110 also includes a key extraction component 208 that extracts key terms from the social content 202 obtained from the various social networking sites 112 and 116 and stores the social content in the content indexed according to the extracted key terms.

Those skilled in the art will appreciate that the various components described above, including the query parsing component 814, access filter component 816, key extraction component 208, presentation generation component 818 and others may be implemented as executable software modules within the search engines 110, as hardware modules, or a combination of the two. Moreover, each of the various components may be implemented as an independent, cooperative process or device, operating in conjunction with the search engine 110. It should be further appreciated, of course, that the various components described above in regard to the search engine 110 should be viewed as logical components for carrying out the various described functions. As those skilled in the art appreciate, logical components (or subsystems) may or may not correspond directly in a one-to-one manner to actual components. In an actual embodiment, the various components identified as being part of the search engine 110 in FIG. 8 may be combined together or broke up across multiple actual components and/or implemented as cooperative processes on a computer network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a requesting computer user, the method comprising:
obtaining social content from one or more of social networking sites corresponding a plurality of computer users, the social content comprising a plurality of items of social content;
storing obtained social content in a content store
receiving a search query from a computer user, the search query being directed to social content posted by a second computer user;
identifying a set of search results responsive to the search query from the content store, the set of search results including at least one item of obtained social content;
filtering the social content in the set of search results according to privacy constraints on the social content;
generating a presentation of the filtered set of search results; and
providing the presentation of the filtered set of search results to the requesting computer user.

2. The computer-implemented method of claim 1, wherein obtaining social content from one or more social network sites corresponding to a plurality of computers comprises:
for each of a plurality of computer users:
obtaining social content from one or more of social networking sites corresponding to one of the plurality of computer users, wherein each item of social content comprises both content and content data.

3. The computer-implemented method of claim 1 further comprising:
for each instance of social content of the obtained social content:
extracting key terms from an instance of social content; and
adding the instance of social content to the content store, wherein the instance of social content is indexed in the content store according to the extracted key terms.

4. The computer-implemented method of claim 3, wherein the social content comprises the content and related social content data.

5. The computer-implemented method of claim 4, wherein extracting key terms from an instance of social content comprises extracting key terms from the related social content data of the instance of social content.

6. The computer-implemented method of claim 3, wherein the related social content data includes an Uploader ID comprising an identifier of the person that uploaded the instance of social content to the social network site.

7. The computer-implemented method of claim 6, wherein filtering the social content in the set of search results according to privacy constraints on the social content comprises determining the access privileges of the requesting computer user with regard to social content posted by the person identified by the Uploader ID.

8. The computer-implemented method of claim 1, wherein the social content comprises and image and related image data.

9. The computer-implemented method of claim 8, wherein the related image data comprises any of: an Uploader ID comprising an identifier of the person that uploaded the instance of social content to the social network site; an album title in which the obtained image is found, album comments; tagged entities in the image; image titles; images comments; location information; the date that the image was taken; the time that the image was taken; data regarding the popularity of the image; and the date the image was uploaded to the social networking site.

10. A computer-readable medium bearing computer-executable instructions which, when executed on a computing system comprising at least a processor executing instructions retrieved from the medium, carry out a method for responding to a search query from a user, the method comprising:
obtaining social content from one or more of social networking sites corresponding a plurality of computer users, the social content comprising a plurality of instances of social content;
storing obtained social content in a content store
receiving a search query from a computer user, the search query being directed to social content regarding a second computer user;
identifying a set of search results responsive to the search query from the content store, the set of search results including at least one instance of obtained social content;
filtering the social content in the set of search results according to privacy constraints on the social content;
generating a presentation of the filtered set of search results; and
providing the presentation of the filtered set of search results to the requesting computer user.

11. The computer-readable medium of claim 10, wherein obtaining social content from one or more social network sites corresponding to a plurality of computers comprises:
for each of a plurality of computer users:
obtaining social content from one or more of social networking sites corresponding to one of the plurality of computer users, wherein each instance of social content comprises both content and content data.

12. The computer-readable medium of claim 10, wherein the method further comprises:
for each instance of social content of the obtained social content:
extracting key terms from an instance of social content; and
adding the instance of social content to the content store, wherein the instance of social content is indexed in the content store according to the extracted key terms.

13. The computer-readable medium of claim 12, wherein the social content comprises the content and related social content data.

14. The computer-readable medium of claim 13, wherein extracting key terms from an instance of social content comprises extracting key terms from the related social content data of the instance of social content.

15. The computer-readable medium of claim 12, wherein the related social content data includes an Uploader ID comprising an identifier of the person that uploaded the instance of social content to the social network site.

16. The computer-readable medium of claim 15, wherein filtering the social content in the set of search results according to privacy constraints on the social content comprises determining the access privileges of the requesting computer user with regard to social content posted by the person identified by the Uploader ID.

17. The computer-readable medium of claim 10, wherein the social content comprises and image and related image data.

18. A computer system for responding with search results to a search query, the system comprising a processor and a memory, wherein the processor executes instructions stored in the memory as part of or in conjunction with additional components to respond to a search query, the additional components comprising:
a key extraction component that, for each of a plurality of instances of social content corresponding to a plurality of computer users, extracts key terms from each instance of social content and stores the social content in a content store and indexed according to the key terms, wherein each instance of social content comprises both content and related social content data;
a query parsing component that, upon receiving a search query from a requesting computer user, the search query being directed to social content posted by a second computer user, identifies a plurality of key terms for identifying social content in the content store;
a content retrieval component that identifies a set of search results from the content store, wherein the set of search results includes at least one instance of social content;
an access filter component that filters the at least one instance of social content in the set of search results according to access privileges of the requesting computer user with regard to the at least one instance of social content; and
a presentation generation component that generates a presentation of the filtered set of search results and returns the presentation to the requesting computer user.

19. The computer system of claim 18, wherein the related social content data includes an Uploader ID comprising an identifier of the person that uploaded the instance of social content to the social network site; and
wherein the access filter component determines the access privileges of the requesting computer user with regard to the at least one instance of social content according to access permission of the requesting computer user to social content posted by the person identified by the Uploader ID.

20. The computer system of claim 18, wherein the social content comprises and image and related image data.
